(19) United States
(12) Patent Application Publication
(10) Pub. No.: US 2024/0364055 A1
(43) Pub. Date: Oct. 31, 2024

(54) Connector and Device Comprising the Same

(71) Applicant: Tyco Electronics (Shanghai) Co., Ltd., Shanghai (CN)

(72) Inventors: Hengkang Wu, Dongguan (CN); Xinjie (David) Zhang, Shanghai (CN)

(73) Assignee: Tyco Electronics (Shanghai) Co., Ltd., Shanghai (CN)

(21) Appl. No.: 18/647,359

(22) Filed: Apr. 26, 2024

(30) Foreign Application Priority Data
Apr. 28, 2023 (CN) 202310492847.5

(51) Int. Cl. H01R 13/6471

(52) U.S. Cl. CPC H01R 13/6471

(57) ABSTRACT

A connector comprises a housing, at least one row of terminals, at least one row of cables, and at least one grounding element. The at least one row of terminals is installed in the housing, and each row of the terminals includes at least one pair of signal terminals and grounding terminals respectively located on opposite sides of each pair of the signal terminals. The at least one row of cables is respectively connected to the terminals. Each of the cables includes a pair of grounding wires and a pair of signal wires connected to respective ones of each pair of the signal terminals. Each of the at least one grounding element at least partially covers a portion of each of the signal terminals electrically connected to corresponding one of the signal wires, and is electrically connected to each of the grounding terminals.

### CROSS-REFERENCE TO RELATED APPLICATION

This application claims the priority of Chinese Patent Application No. CN 202310492847.5 filed on Apr. 28, 2023, the whole disclosure of which is incorporated herein by reference.

### FIELD OF THE INVENTION

The present application relates to a connector and a device comprising the same.

### BACKGROUND

A connector is a device used to connect two active devices to transmit current or signals. A connector may simplify the assembly process of electronic products and also simplify the mass production process of electronic products. A connector is easy to repair, and if an electronic element fails, the faulty electronic element may be quickly replaced by having a connector installed. With the advancement of technology, electronic products equipped with connectors may facilitate updating electronic elements, replacing old electronic elements with new and better performing ones for easy upgrading. A connector may also enhance the flexibility of product design when designing and integrating new products, as well as when composing a system with electronic elements. As a result of these benefits, connectors are widely used in fields such as transportation, healthcare, aerospace, military, and home appliances.

The basic performances of a connector may be divided into three categories: mechanical performance, electrical performance, and environmental performance. More specifically, plugging force and mechanical life are important mechanical performances. The plugging force and mechanical life of a connector are related to a structure (positive pressure) of an element contacting with the connector, a coating quality (sliding friction coefficient) of a contact area, and a size accuracy of a contact arrangement (alignment). Main electrical performances of a connector include a contact resistance, an insulation resistance, and a dielectric strength. Among them, a high-quality electrical connector should have a low and stable contact resistance, which ranges from a few milliohms to tens of milliohms. An insulation resistance is an index that indicates an insulation performance between contacts of an electrical connector and between the contacts and a housing of the electrical connector. An order of magnitude of the insulation resistance ranges from hundreds of megaohms to thousands of megaohms. Dielectric strength is an ability of the electrical connector to withstand a rated test voltage between the contacts of the electrical connector or between the contacts and the housing of the electrical connector. Environmental performance comprises temperature resistance, humidity resistance, salt spray resistance, vibration and impact resistance, etc.

The development of connector technology has focused on speed and digitization of signal transmission, integration of various types of signal transmission, miniaturization of product volume, low cost of products, modular combination, convenience of plugging and the like.

In existing connectors having at least one row of terminals, signal terminals of each row of terminals are usually exposed, resulting in signal interferences between the signal terminals of each row of the terminals. This limits available improvement of signal integrity. Grounding terminals located between the signal terminals of each row of the terminals cannot shield the signal interferences between adjacent signal terminals, which further limits the improvement of the signal integrity. As a result, existing connectors cannot be used in applications with high requirements for the signal integrity.

### SUMMARY

According to one embodiment of the present disclosure, a connector comprises a housing, at least one row of terminals, at least one row of cables, and at least one grounding element. The at least one row of terminals is installed in the housing. Each row of the terminals includes at least one pair of signal terminals and grounding terminals respectively located on opposite sides of each pair of the signal terminals. The at least one row of cables is respectively connected to the terminals. Each of the cables includes a pair of grounding wires and a pair of signal wires respectively connected to each pair of the signal terminals. Each of the at least one grounding element at least partially covers a portion of each of the signal terminals electrically connected to corresponding one of the signal wires and is electrically connected to each of the grounding terminals.

### BRIEF DESCRIPTION OF THE DRAWINGS

The invention will now be described by way of example with reference to the accompanying Figures, of which:

FIG. 1 is a perspective view of a connector according to an embodiment of the present application;

FIG. 2 is a side view of the components of the connector shown in FIG. 1 with removing the housing, showing two holders, two grounding elements, two rows of terminals and two rows of cables connected together;

FIG. 3 is a side view of the components shown in FIG. 2 with removing the holders;

FIG. 4 is a top view of the components of the connector in FIG. 2;

FIG. 5 is a cross-sectional view of one holder, one grounding element, one row of terminals and one row of cables connected together, taken along line V-V shown in FIG. 4;

FIG. 6 is a perspective view showing one holder, one grounding element, one row of terminals and one row of cables connected together in the connector according to an embodiment of the present application;

FIG. 7 is a perspective view showing one holder, one row of terminals and one row of cables connected together in the connector according to an embodiment of the present application; and

FIG. 8 is a perspective view of a single grounding element according to an embodiment of the present application.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the case of using the expression like “at least one of A, B, and C, etc.”, it should be generally explained according to the meaning of the expression generally understood by those skilled in the art (for example, “a system having at least one of A, B and C” should comprise but is not limited to systems having only A; having only B; having only C, having A and B; having A and C; having B and C, and/or having A, B and C; etc.). In the case of using the expression like “at least one of A, B, or C, etc.”, it should be generally explained according to the meaning of the expression generally understood by those skilled in the art (for example, “a system having at least one of A, B or C” should comprise but is not limited to systems having only A; having only B; having only C; having A and B; having A and C; having B and C; and/or having A, B and C; etc.).

All terms used herein (comprising technical and scientific terms) have the meanings generally understood by those skilled in the art, unless otherwise defined. It should be noted that the terms used herein should be interpreted as having the meaning consistent with the context of this specification or description, and should not be interpreted in an idealized or overly rigid manner.

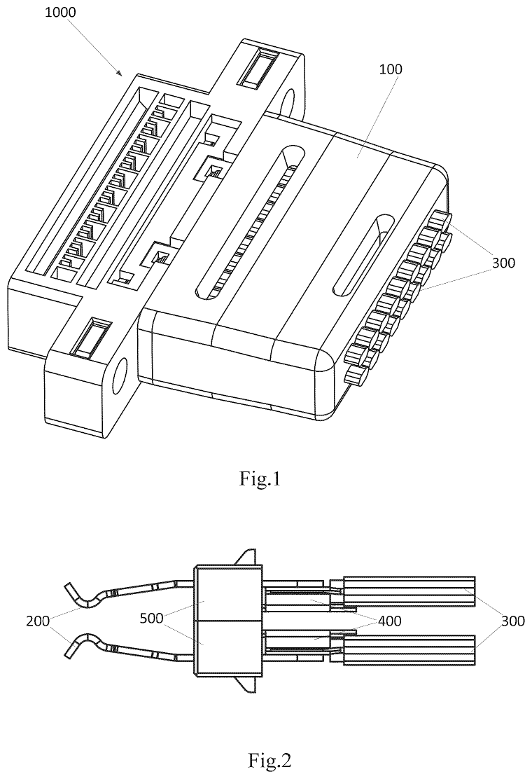

As shown in FIGS. 1-8, present application discloses a connector 1000 and a device comprising the connector. The connector 1000 comprises a housing 100, at least one row of terminals 200 installed in the housing 100, holders 500 installed in the housing 100, at least one row of cables 300 and at least one grounding element 400. Each row of terminals 200 of the at least one row of terminals are disposed on a respective one of the holders 500.

Each row of the terminals 200 comprises at least one pair of signal terminals 210 and grounding terminals 220 respectively located on opposite sides of each pair of the signal terminals 210. Each of the cables 300 is connected to corresponding one of the terminals 200 and comprises a pair of grounding wires 320 and a pair of signal wires 310 respectively connected to each pair of the signal terminals 210. The grounding element 400 at least partially covers a portion of each of the signal terminals 210 electrically connected to corresponding one of the signal wires 310. The ground element 400 is spaced from the electrically connected portion and electrically connected to each of the grounding terminals 220. This not only significantly shields electromagnetic waves (i.e., signal interferences) radiated by the covered signal terminals 210 and the covered signal wires 310 to an environment, but also significantly shields influence (i.e., signal interferences) of external electromagnetic waves from the environment on the covered signal terminals 210 and the covered signal wires 310, effectively improving a signal integrity of the connector 1000.

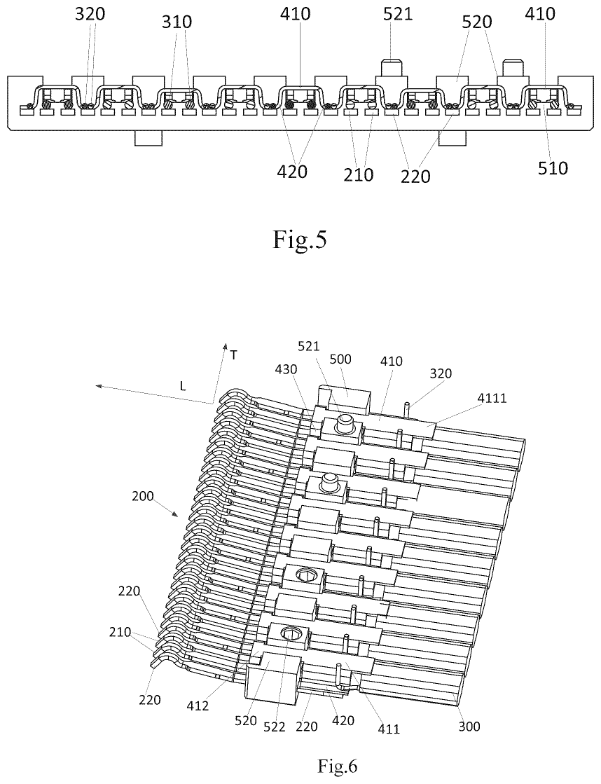

Referring to FIGS. 5-7, each of the grounding wires 320 of the cables 300 is electrically connected to corresponding one of the grounding terminals 220 via the grounding element 400. Referring to FIG. 8, the grounding element 400 is an integral component, constructed into a wave shape having peaks and troughs distributed alternately with each other, so that the grounding element 400 and each of the grounding terminals 220 form at least two contact points (i.e., the two contact points respectively formed by each of first grounding arms 420 and each of second grounding arms 430 mentioned below with corresponding one of the grounding terminals 220) in a longitudinal direction L. In other words, the grounding element 400 contacts with each of the grounding terminals 220 at at least two contact points in a direction L in which the grounding terminal 220 extends. Therefore, the ground terminals 220 of each row of the terminals 200 and the grounding wires 320 of each row of the cables 300 are electrically connected together by one and the same integral component (i.e., the grounding element 400), which significantly shortens signal return paths and further effectively improves the signal integrity of the connector 1000.

Still referring to FIGS. 5-8, each said grounding element 400 comprises at least one grounding unit. Each grounding unit includes a flat grounding plate 410 extending in the longitudinal direction L along each pair of the signal terminals 210 and each pair of the signal wires 310 connected to each pair of the signal terminals 210, so as to at least partially cover each pair of the signal terminals 210 and each pair of the signal wires 310 and be spaced from each pair of the signal terminals 210 and each pair of the signal wires 310. The flat grounding plate 410 forms the peak of the wave shape mentioned above.

Each grounding unit further comprises two first grounding arms 420, each of which extends transversely (i.e., in a transverse direction T perpendicular to the longitudinal direction L, see FIGS. 6-8) from an end 411 of the grounding plate 410 downwardly to an adjacent one of the grounding terminals 220. Each grounding arm 420 is integrated with a first grounding arm 420 of an adjacent grounding unit, so that each of the first grounding arms 420 is placed against and between the grounding terminal 220 and a corresponding one of the grounding wires 320. The two adjacent first grounding arms 420 connected together form a portion of a trough of the wave shape mentioned above.

Referring to FIGS. 4-7, each of the holders 500 comprises at least one first holding portion 510 and at least one pair of second holding portions 520. Each pair of the signal terminals 210 extend through and are fixed by the first holding portion 510. The at least one pair of second holding portions 520 are respectively located on opposite sides of each said first holding portion 510 and protrude beyond (i.e., above) the first holding portion 510. Each of the grounding terminals 220 extends through and is fixed by corresponding one of the second holding portions 520. The flat grounding plate 410 is located between a pair of second holding portions 520 and extends across corresponding one of the holders 500 above the first holding portion 510 between the pair of second holding portions 520 and is spaced from the first holding portion 510. The grounding plate 410 is located at a height lower than the pair of second holding portions 520. That is, each said grounding plate 410 extends between each pair of second holding portions 520 across corresponding one of the holders 500 and covers the first holding portion 510.

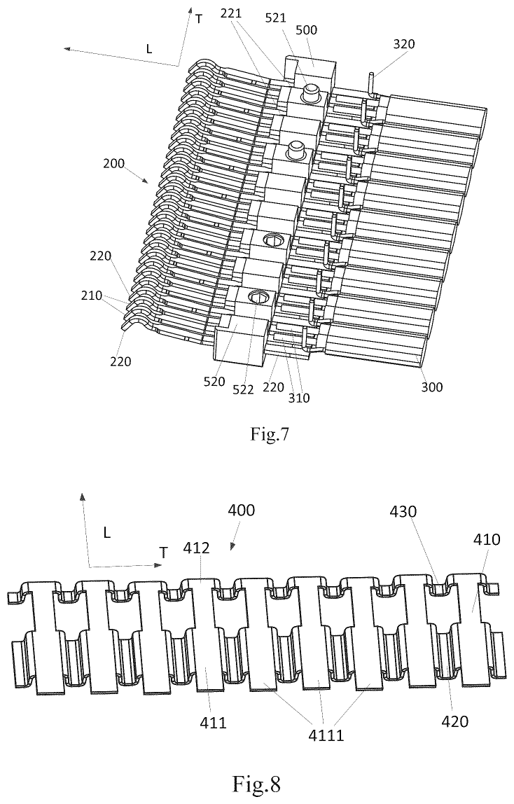

With reference to FIGS. 4-8, each said grounding unit further comprises two second grounding arms 430, each of which extends transversely (i.e., in a transverse direction T perpendicular to the longitudinal direction L, see FIGS. 6-8) from the other end 412 of the grounding plate 410 downwardly to a portion 221 (see FIG. 7) of an adjacent one of the grounding terminals 220 that is exposed from the corresponding one of the second holding portions 520 and is integrated with a second grounding arm 430 of an adjacent grounding unit. The two adjacent second grounding arms 430 connected together form another portion of the trough of the wave shape mentioned above, and are spaced apart from the two adjacent first grounding arms 420 connected together in the longitudinal direction L (see FIG. 8) so that one of the second holding portions 520 is accommodated in the spacing between the two adjacent first grounding arms 420 and the two adjacent second grounding arms 430. The existence of the trough not only provides the two contact points formed respectively by the first and second grounding arms 420, 430 and the grounding terminal 220, but also significantly shields the signal interferences between adjacent pairs of signal terminals 210, further improving the signal integrity of the connector 1000.

Referring specifically to FIGS. 2-4, 6 and 8, the grounding plate 410 is provided with an extension portion 4111 extending out from the end 411 to partially cover an insulating sheath of corresponding one of the cables 300, so as to further reduce the signal interferences from the signal wires 310 of any of the other cables 300 exposed outside its insulating sheath.

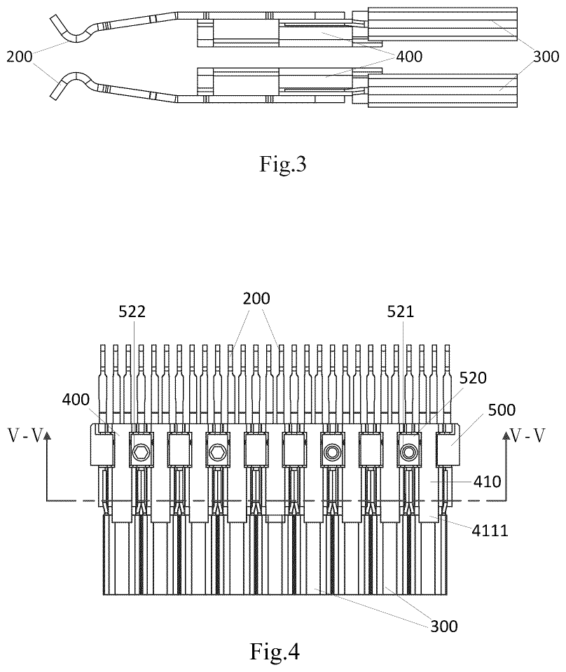

In one embodiment of the present disclosure (see FIGS. 2 and 3), the at least one row of terminals 200 comprises two rows of terminals 200 arranged to face each other. The at least one row of cables 300 comprises two rows of cables 300 respectively arranged to be connected to the two rows of terminals 200. The at least one grounding element 400 comprises two grounding elements 400, each of which is arranged on corresponding one of the two rows of terminals 200 and located between the two rows of terminals 200. One of the two holders 500 is provided with at least one of a protrusion 521 and a recess 522 matching with the former on at least one of its second holding portions 520, and the other one of the two holders 500 is provided with at least one of the protrusion 521 and the recess 522 on at least one of its second holding portions 520, so that the two holders 500 match and connect with each other by the protrusion and the recess, and thus the two rows of terminals 200 respectively fixed to the two holders 500 are arranged opposite to or face each other in the housing 100. However, those skilled in the art should understand that the described embodiments are not limited to this. The at least one row of terminals 200 may also comprise a plurality of rows of terminals 200, and the at least one row of cables 300 may also comprise a plurality of rows of cables 300.

The embodiments of the present application have been described in detail in combination with the drawings. It should be noted that the implementation methods not illustrated or described in the drawings or the description are in forms known to those skilled in the art and are not described in detail. In addition, the above definitions of individual parts are not limited to various specific structures, shapes or modes mentioned in the embodiments, which may be simply changed or replaced by those skilled in the art.

It should also be noted that in the specific embodiments of the present application, unless explicitly specified, the numerical parameters in the specification and the appended claims are approximate values and may be changed according to the required characteristics obtained through the content of the present application. Specifically, all numbers used in the description and claims to indicate the sizes, scope conditions, etc. of the components should be understood as being modified by the term “about” in all cases. In general, the meaning of its expression is to comprise a variance of ±10% in some embodiments, a variance of ±5% in some other embodiments, a variance of ±1% in still some other embodiments, and a variance of ±0.5% in the other embodiments.

Those skilled in the art may understand that the features recorded in the various embodiments and/or claims of the present application may be combined or/or associated in a variety of ways, even if such a combination or association is not clearly recorded in the present application. In particular, the features recorded in the various embodiments and/or claims of the present application may be combined and/or associated in a variety of ways, without departing from the spirits and teachings of the present application. All of these combinations and/or associations fall within the scope of the present application.

The specific embodiments described above further explain the purposes, technical schemes and beneficial effects of the present application in detail. It should be understood that the above descriptions are only specific embodiments of the present application and are not intended to limit the present application. Any modification, equivalent replacement, improvement, etc. made within the spirits and principles of the present application should be comprised in the protection scope of the present application.

What is claimed is:

1. A connector, comprising:
a housing;
at least one row of terminals installed in the housing, each row of the terminals including:
at least one pair of signal terminals; and
grounding terminals located on opposite sides of each pair of signal terminals;
at least one row of cables connected to the terminals, each of the cables including:
a pair of grounding wires; and
a pair of signal wires connected to each pair of the signal terminals; and
at least one grounding element, each grounding element at least partially covers a portion of each of the signal terminals electrically connected to corresponding one of the signal wires, and is electrically connected to each of the grounding terminals.

2. The connector according to claim 1, wherein the grounding element contacts each of the grounding terminals at two contact points in a direction in which the grounding terminal extends.

3. The connector according to claim 1, wherein each of the grounding wires of the cables is electrically connected to a corresponding one of the grounding terminals via the grounding element.

4. The connector according to claim 1, wherein each grounding element comprises at least one grounding unit including a grounding plate extending along each pair of the signal terminals and each pair of the signal wires connected to each pair of the signal terminals, the grounding plate at least partially covering a respective one of each pair of the signal terminals and each pair of the signal wires.

5. The connector according to claim 4, wherein each grounding unit further comprises two first grounding arms.

6. The connector according to claim 5, wherein each first grounding arm extends transversely from a first end of the grounding plate to an adjacent one of the grounding terminals and is integrated with a first grounding arm of an adjacent grounding unit, so that each of the first grounding arms is placed against and between the grounding terminal and corresponding one of the grounding wires.

7. The connector according to claim 6, further comprising holders installed in the housing, each row of terminals of the at least one row of terminals being respectively disposed on one of the holders.

8. The connector according to claim 7, wherein each of the holders comprises:
at least one first holding portion through which each pair of the signal terminals extend; and
at least one pair of second holding portions respectively located on opposite sides of each first holding portion and protruding beyond the first holding portion, each of the grounding terminals extending through corresponding one of the second holding portions.

9. The connector according to claim 8, wherein each grounding plate extends between each pair of the second holding portions across a corresponding one of the holders and covers the first holding portion.

10. The connector according to claim 9, wherein each grounding unit further comprises two second grounding arms.

11. The connector according to claim 10, wherein each second grounding arm extends transversely from a second end of the grounding plate to a portion of an adjacent one of the grounding terminals that is exposed from corresponding one of the second holding portions, and is integrated with a second grounding arm of an adjacent grounding unit.

12. The connector according to claim 6, wherein the grounding plate is provided with an extension portion extending out from the first end to partially cover an insulating sheath of a corresponding one of the cables.

13. The connector according to claim 12, wherein:
the at least one row of terminals comprises two rows of terminals arranged to face each other; and
the at least one row of cables comprises two rows of cables respectively arranged to be connected to the two rows of terminals.

14. The connector according to claim 13, wherein the at least one grounding element comprises two of the grounding elements, each grounding element is arranged on a corresponding one of the two rows of terminals and located between the two rows of terminals.

15. The connector according to claim 8, wherein one of the holders is provided with at least one of a protrusion and a recess on at least one of its second holding portions, and another one of the holders is provided with at least one of the protrusion and the recess on at least one of its second holding portions, the holders being mateable with each other via engagement of the protrusion and the recess.

16. A connector, comprising:
a housing;
a row of terminals installed in the housing, including:
a pair of signal terminals; and
grounding terminals located on opposite sides of the pair of signal terminals;
a row of cables connected to the terminals, each cable including:
a pair of grounding wires; and
a pair of signal wires connected to each pair of the signal terminals; and
a grounding element at least partially covering a portion of each of the signal terminals electrically connected to corresponding one of the signal wires, and electrically connected to each of the grounding terminals.

17. The connector according to claim 16, wherein the grounding element contacts with each of the grounding terminals at two contact points in a direction in which the grounding terminal extends.

18. The connector according to claim 16, wherein each of the grounding wires of the cable is electrically connected to a corresponding one of the grounding terminals via the grounding element.

19. The connector according to claim 16, wherein the grounding element comprises:
a grounding plate extending along and at least partially covering the pair of signal terminals and the pair of the signal wires connected to the pair of signal terminals; and
two first grounding arms, each of which extends transversely from a first end of the grounding plate to an adjacent one of the grounding terminals, each of the first grounding arms is placed against and between the grounding terminal and corresponding one of the grounding wires.

20. The connector according to claim 19, wherein the grounding element further comprises two second grounding arms, each of which extends transversely from a second end of the grounding plate.
